(19) United States
(12) Patent Application Publication
(10) Pub. No.: US 2013/0008104 A1
(43) Pub. Date: Jan. 10, 2013

(54) BUILDING CONSTRUCTION FOR MAKING TRANSPIRABLE WALLS AND FLOORS

(76) Inventor: Michele Caboni, Oristano (IT)

(21) Appl. No.: 13/261,248

(22) PCT Filed: Oct. 1, 2010
(86) PCT No.: PCT/IB2010/002498

§ 371 Date: Sep. 18, 2012

(30) Foreign Application Priority Data
Oct. 2, 2009 (IT) MI2009A001696

(51) Int. Cl. E04B 1/70; E06B 1/32

(52) U.S. Cl. 52/204.1; 52/302.1

(57) ABSTRACT

The present invention relates to a building construction (1) operating as a formwork for making transpirable walls and floors, and being characterized in that said building construction comprises a plurality of foamed plastics material transpirable panels (2,2′) therebetween are arranged perforated coupling elements (3) operating as spacer elements and adapted to join the panels with one another, while allowing air to pass therethrough, said panels including a plurality of cross notches (8) for engaging therein end portions of spacer elements coupling the panels (2 and 2′).

### BACKGROUND OF THE INVENTION

The present invention relates to a building construction, particularly for making transpirable walls and floors.

As is known, to make building elements having structural functions such as walls and floors, while having high mechanical strength and good transpiration properties, represents a very important problem to be solved in civil and industrial building fields.

Another very important problem is that of making such structures which may be easily installed in a short time period.

### SUMMARY OF THE INVENTION

Accordingly, the aim of the present invention is to provide such a building construction allowing to make walls and floors having high transpirable characteristics.

Within the scope of the above mentioned aim, a main object of the invention is to provide such a building construction or structure which may be easily and quickly constructed.

Yet another object of the present invention is to provide such a building construction consisting of light building materials for facilitating their shipment and installation while improving their static functionality.

Yet another object of the present invention is to provide such a building construction which, owing to its specifically designed structural features, is very reliable and safe in operation.

Yet another object of the present invention is to provide such a building construction which may be easily made starting from easily commercially available elements and materials and which, moreover, is very competitive from a mere economic standpoint.

According to one aspect of the present invention, the above mentioned aim and objects, as well as yet other objects, which will become more apparent hereinafter, are achieved by a building construction, particularly for making transpirable walls and floors, characterized in that said building construction comprises transpirable panels, constituting the construction formwork, therebetween connecting elements, constituted by spacer elements designed for joining panels to one another while allowing air to pass therethrough, are arranged.

Each said spacer element comprises a first tubular portion including a finned portion, therein is telescopically engaged a second tubular portion, including holes and having an engagement end portion.

The engagement end portion of the spacer element may be housed in corresponding engagement recesses or seats formed in the panels.

### BRIEF DESCRIPTION OF THE DRAWINGS

Further characteristics and advantages of the present invention will become more apparent hereinafter from the following detailed disclosure of a preferred, though not exclusive, embodiment of the invention which is illustrated, by way of an indicative, but not limitative, example, in the accompanying drawings, where:

FIG. 1 is a perspective view made starting from a formwork forming structure according to the present invention;

FIG. 2 is a top plan view of another exemplary embodiment of a formwork construction according to the present invention;

FIG. 3 is another top plan view of a formwork, according to the present invention, in which it is possible to see the spacer elements for supporting iron reinforcement elements;

FIG. 4 is a top plan view of a formwork to be used for making a pillar according to the present invention;

FIG. 5 is a further top plan view of yet another formwork;

FIG. 6 shows a spacer element of a recessed or flush mounted type;

FIG. 7 shows a spacer element of a projecting or cantilever type;

FIG. 8 shows a 50 mm panel spacer element;

FIG. 9 shows a 75 mm panel spacer element;

FIG. 10 is a perspective view of an iron bearing plate;

FIG. 11 is a perspective view of a floor portion, including two joined elements;

FIG. 12 is a perspective view of another embodiment of the floor according to the present invention;

FIG. 13 is yet another perspective view of a further embodiment of the subject floor;

FIG. 14 shows a portion of ventilated-wall formworks, as seen from the top thereof;

FIG. 15 is a cross-sectional view showing the subject floor;

FIG. 16 shows, in a cross-sectioned side view, a ventilated wall or floor according to the invention;

FIG. 17 shows an exemplary connection between panels 2 and 2′ including, at side surfaces 50 and 51 thereof, a multiple tooth pattern 52 and 53 thereby coupling the panels 2 and 2′ with an orthogonal relationship at different portions and according to different thickness sections, thereby allowing each said panel to be reversed;

FIG. 18 shows two panels having, on both surfaces thereof, dovetail cavities or recesses and/or ridges, for engaging therein separating diaphragms;

FIG. 19 shows the two above panels including cross notches 8, having cross notch slots parallel to the major sides of the panels, said slots operating as anchoring seats for specifically designed spacer elements;

FIG. 20 shows a valve to be engaged in a perforated tubular duct forming an integrating part of the spacer elements which also operate as fitting elements for the formwork walls 2 and 2′;

and

FIG. 21 shows a connector including side uprights engaged in the cross slots formed on the bodies of the panels 2 and 2′.

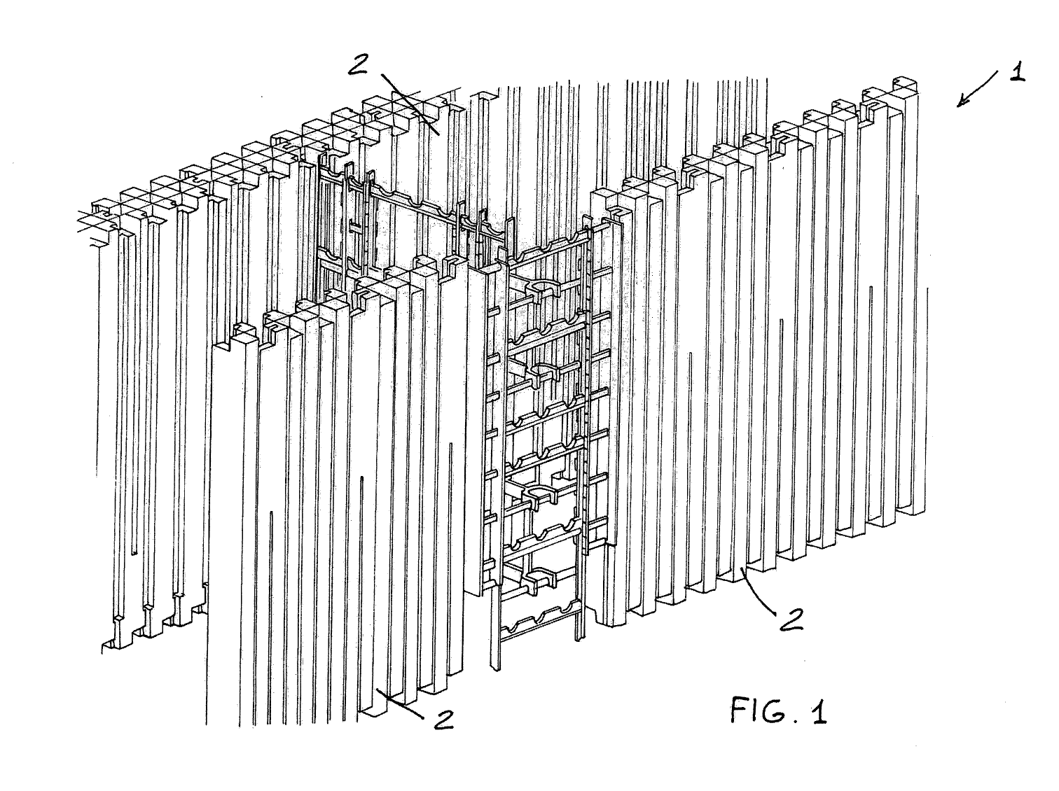

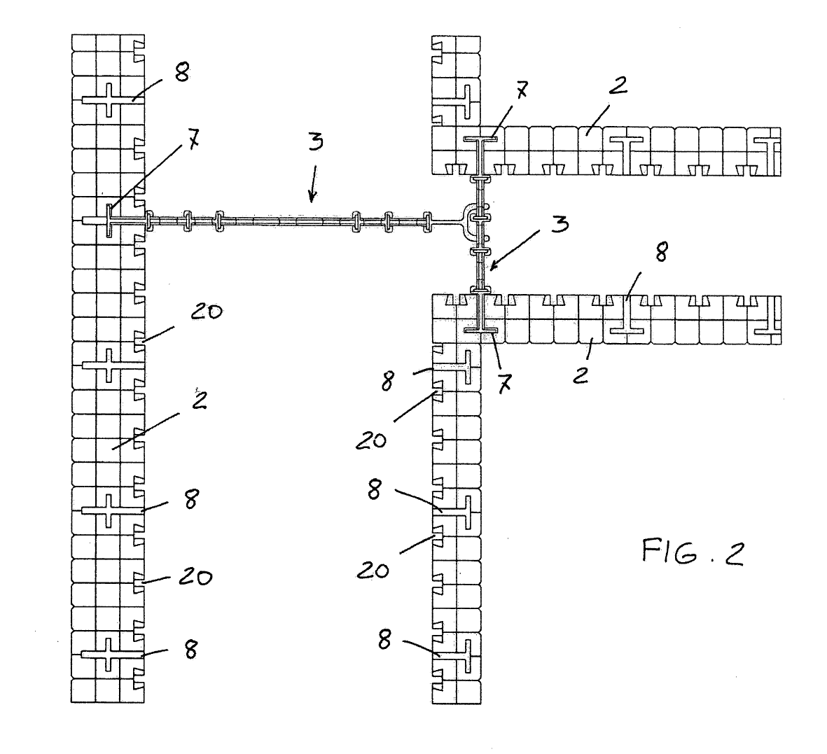

### DESCRIPTION OF THE PREFERRED EMBODIMENTS

With reference to the number references of the above mentioned figures, the building construction according to the present invention, which has been generally indicated by the reference number 1, comprises a plurality of transpirable or transpiring panels 2, made of a polystyrene material, therebetween connecting element including hollow tubular elements 3, constituting spacer elements for joining the panels 2 and to one another, while allowing air to pass therethrough, are arranged.

Each said spacer element 3 comprises a first tubular portion 4, including a hook portion 5, therewithin is telescopically engaged a second tubular portion 6 including an engagement end portion 7.

Said engagement end portion 7 is adapted to engage in corresponding engagement seats or recesses 8 formed in said panels 2.

The panels 2 may be made of transpirable or transpiring materials, such as, for example, foamed or extruded polystyrene, a plywood material, a cement wood material, a mixed cement-perlite material, or suitable adhesive materials, made of cellular cement, tile or plasterboard materials, pumice concrete materials, or other insulating materials.

Since said panels are made of a transpirable or transpiring material, preferably foamed polystyrene, and said fitting spacer elements 3 are hollow and include a plurality of holes, air may pass between the wall surface, even upon pouring a concrete material to finish the construction.

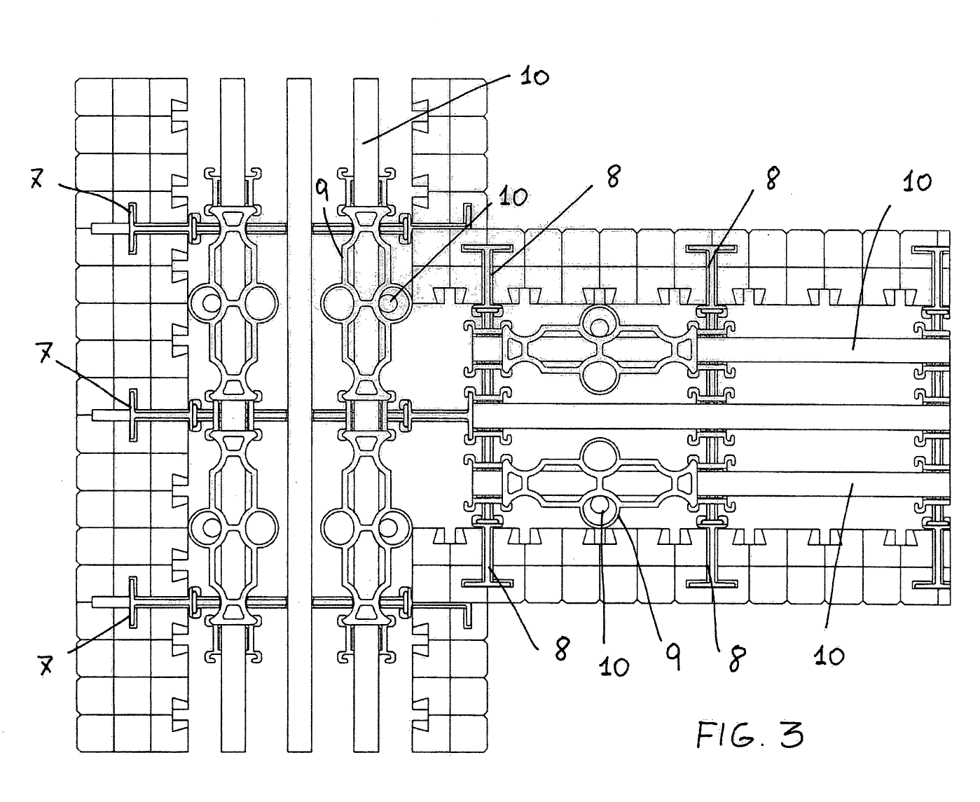

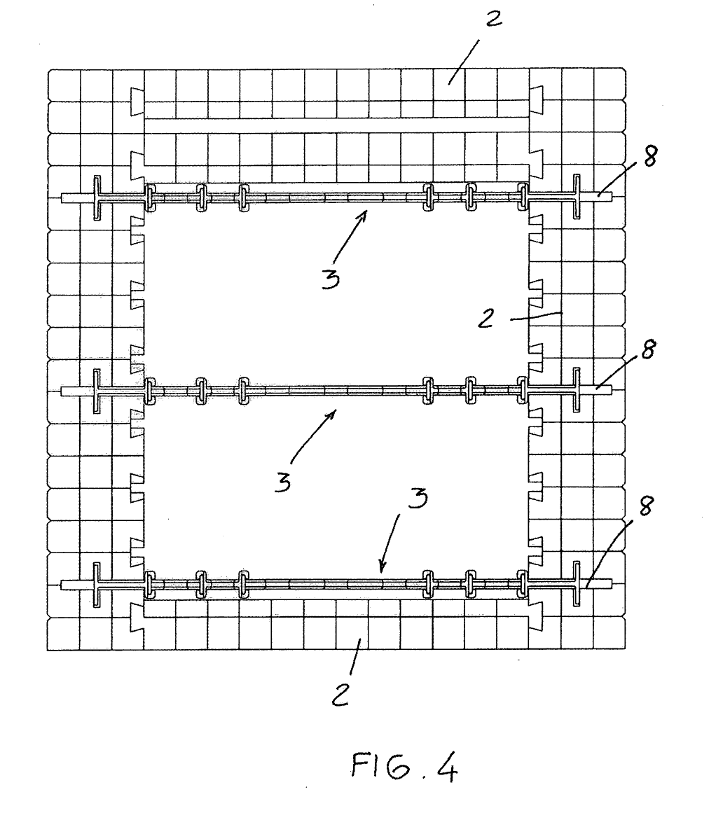

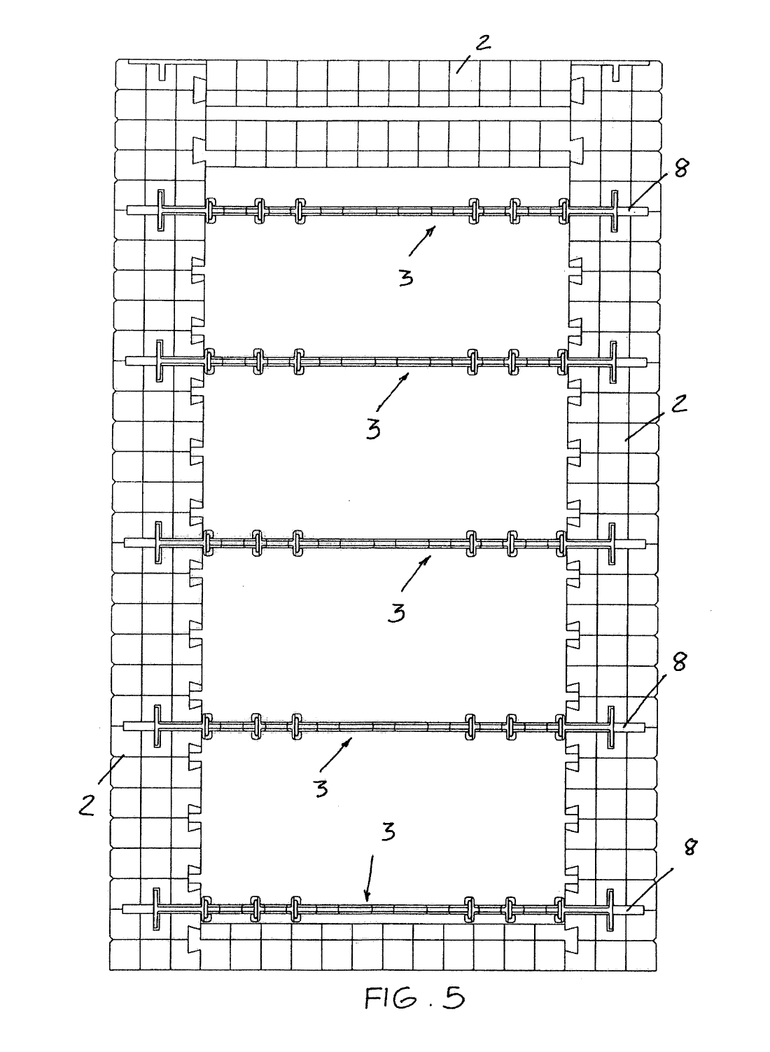

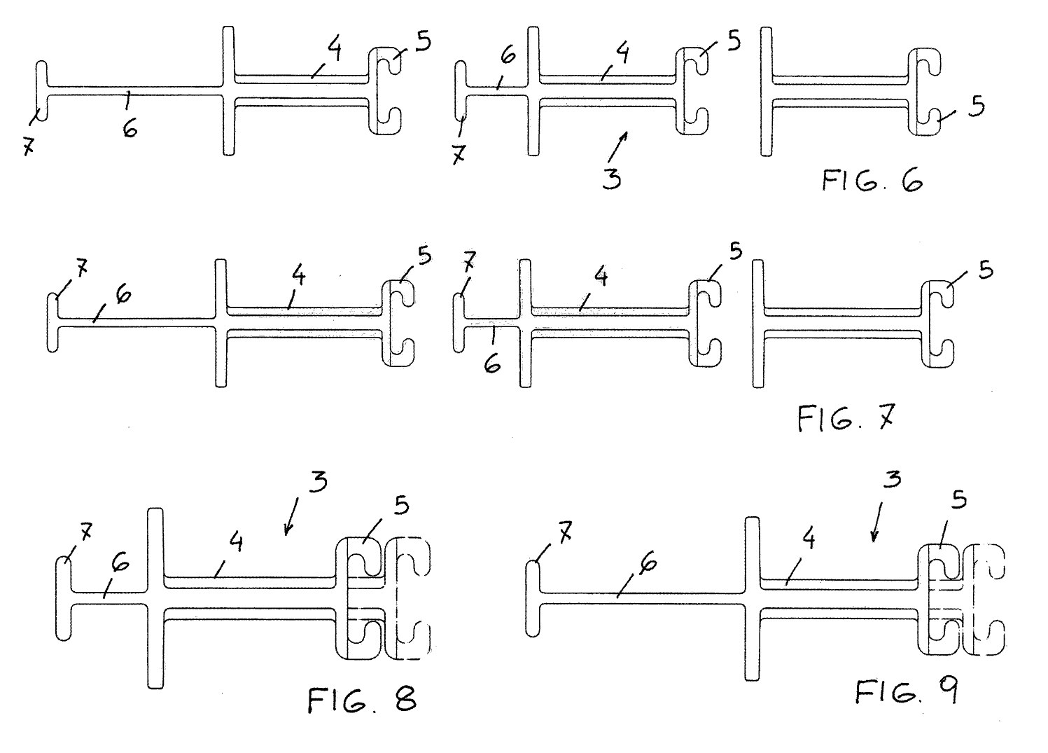

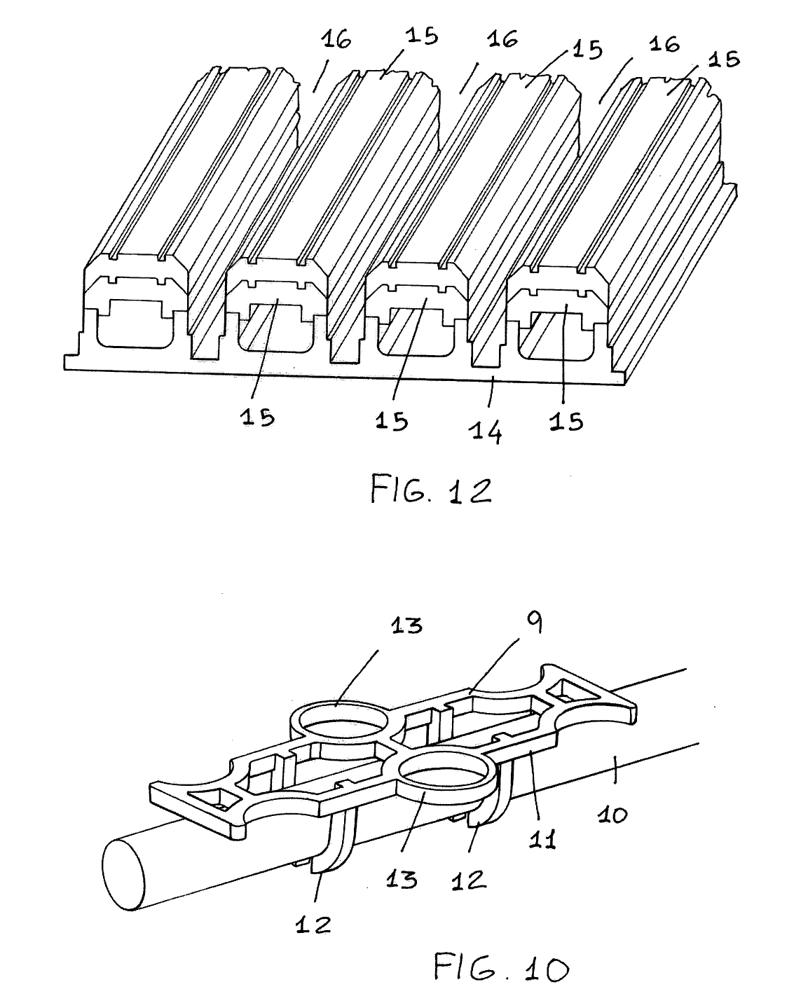

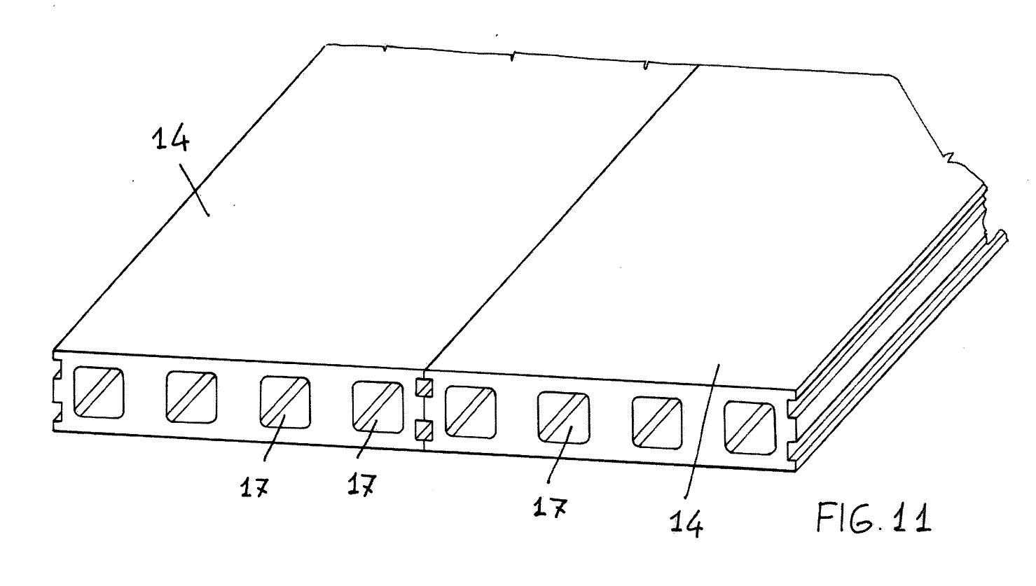

Moreover, support elements 9, which may be associated with the spacer element 3 to support the reinforcement iron elements 10, as is schematically shown in FIG. 3, are herein provided.

The support or hook elements 9 comprise a contoured frame 11 including a plurality of crooks 12 for the horizontal iron reinforcement elements and eyelets 13 for the vertical iron reinforcement elements.

The floor caisson block, shown in FIGS. 11-13, comprises preferably a foamed or extruded polystyrene, cement-wood, plywood or cement mixed perlite, cellular cement or any suitable adhesive, pumice-concrete material or other insulating material base 14.

Said base 14 is suitably shaped as to present a plurality of empty or hollow regions 17 therein technologic systems or plants may be housed.

On said caisson or formwork forming polystyrene base 14, a variable number of polystyrene elements 15, may be applied.

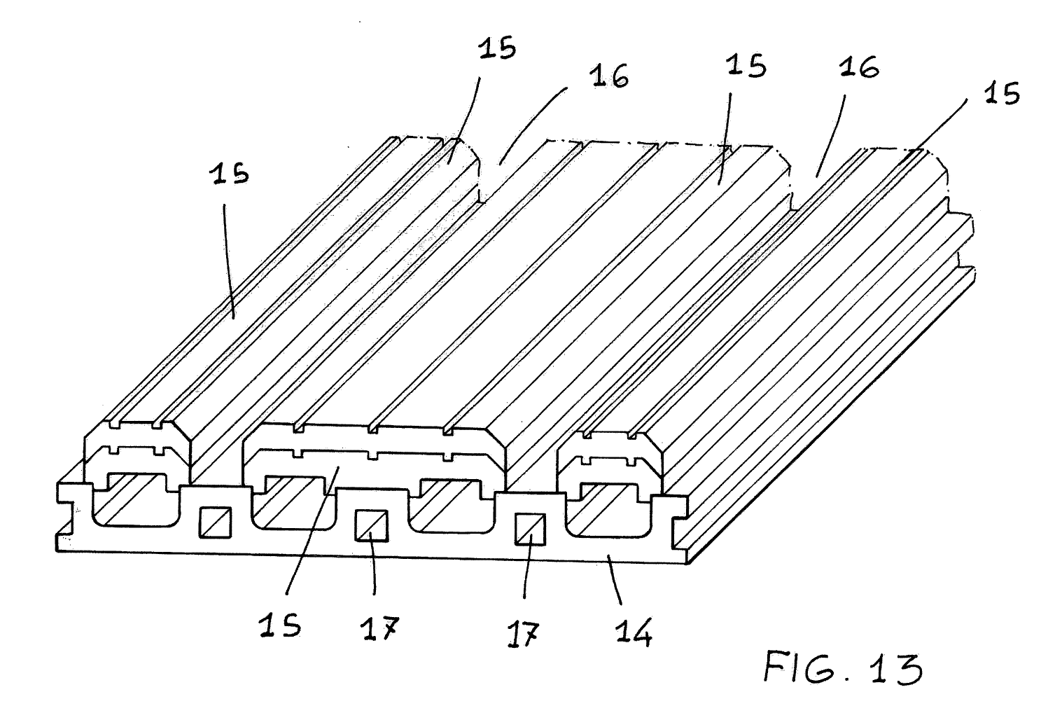

More specifically, the polystyrene elements 15 shown in FIGS. 12 and 13 are overlapped onto one another thereby forming ridge or projecting regions delimiting cavities or recesses 16 therein it is possible to engage different type of reinforcement iron elements, and into which a cement material is poured, thereby forming small beams or monolithic diaphragm, the dimensions of which are delimited by the above mentioned foamed or extruded polystyrene elements forming members adapted to operate as a formwork as the cement material is poured thereinto.

The polystyrene panels 2 forming the subject building construction, operating as an aerated and insulating formwork, in actual practice, may be made in a panel making shop and transported in a gapless stacked or overlapped condition to the building place to be mount thereat.

The transpirable or transpiring gaps may be made at the building yard, by using the above mentioned aerating throughgoing hole connecting elements 3 constituting an integrating part of the present invention.

In this connection it should be pointed out that the insulating panels 2 of the inventive building construction further comprise side hollow or recessed portions 20, therein it is possible to engage separating diaphragms 9 designed for operating as formworks for pouring therein pillars or ledges or lintels and/or door and window jambs.

The above dovetail side cavities or recesses 20 also operate as elements for facilitating plaster material coating operations.

As stated, said panels 2 comprise, at one or more surfaces thereof, said dovetail cavities or recesses 20 therein corresponding dovetail ridges 24, formed on the panels 2′ to be coupled to said panels 2, are provided.

Thus, it is possible to make insulating walls 2″ having different thicknesses, by coupling to one another several panels 2 and 2′.

Said panels 2, 2′ are installed by using the above mentioned connecting elements 3, operating as spacer elements, thereby providing walls 2″ which may have different distances from one another and accordingly comprise wall gaps 23 formed between a panel 2 and an adjoining panel 2′.

Thus, it is possible to make transpirable gaps 23 of different dimensions, in which it is possible to house the above mentioned technologic systems or plants.

Moreover, the panels 2 and 2′ will be ventilated both in their inside and on their outside.

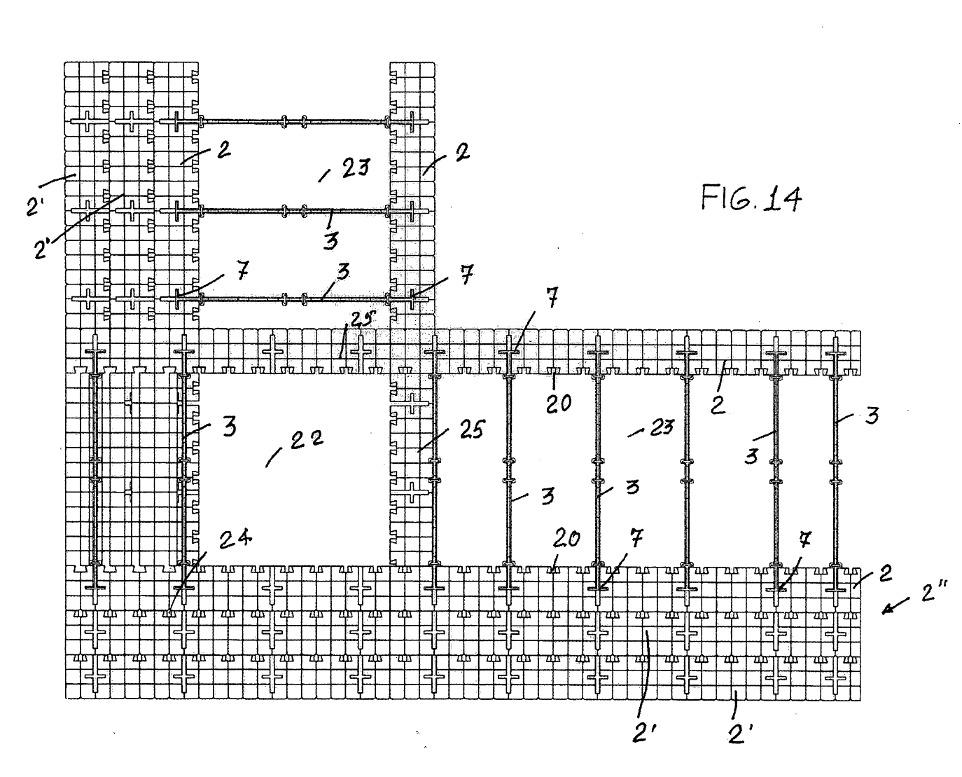

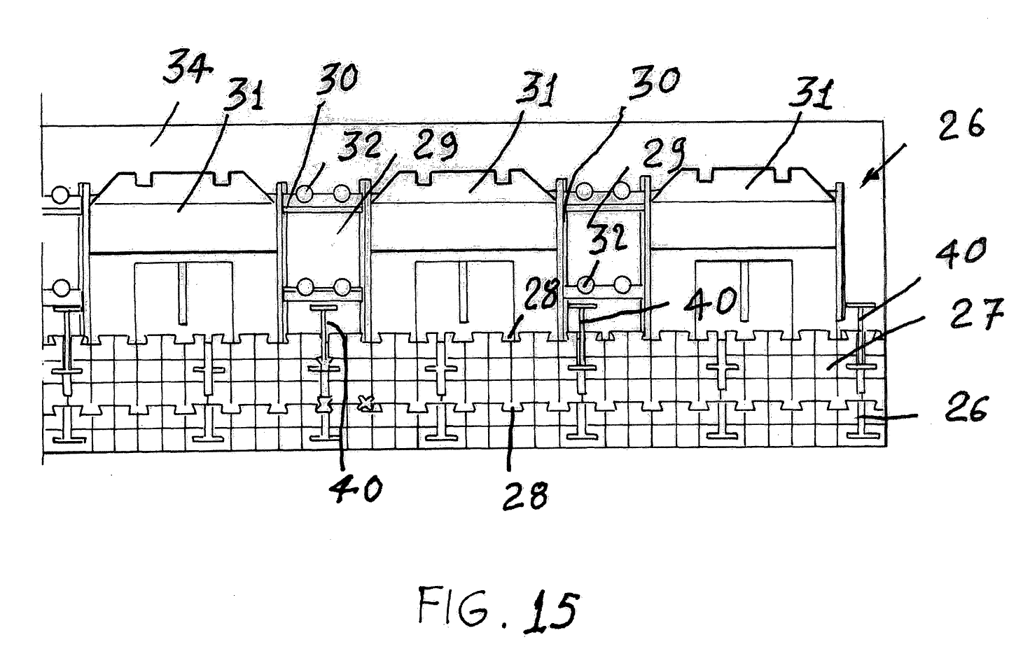

FIG. 14 shows a portion of panels 2, 2′, 25 as seen from the top.

More specifically, the walls 2, 2′ and 25 define a cavity or space 22, to be used as a formwork, including reinforcement iron elements and thereinto it is possible to pour a concrete material to form the support pillars of the constructions

That same panels 2, 2′ may also comprise cavities and dovetail lungs, thereby allowing said walls 2, 2′ to be easily connected.

FIG. 15 shows a cross-sectional view of the subject floor.

In particular, FIG. 15 shows a floor comprising a base element 26 made of foamed or extruded polystyrene or of any other above mentioned materials, to which is coupled, by dovetail cavities, a frame or intrados 27 including corresponding dovetail ridges or projections 28.

FIG. 15 shows moreover “H” shape connecting bars 40, connecting said floor or intrados 27 to a plurality of small beams 29 made by pouring a cement material into the cavities 30 formed between foamed or extruded polystyrene cup elements 31.

In said cavities 30 reinforcement iron elements 32 are moreover arranged.

In operation, a concrete layer 34 is poured above said cup elements 31.

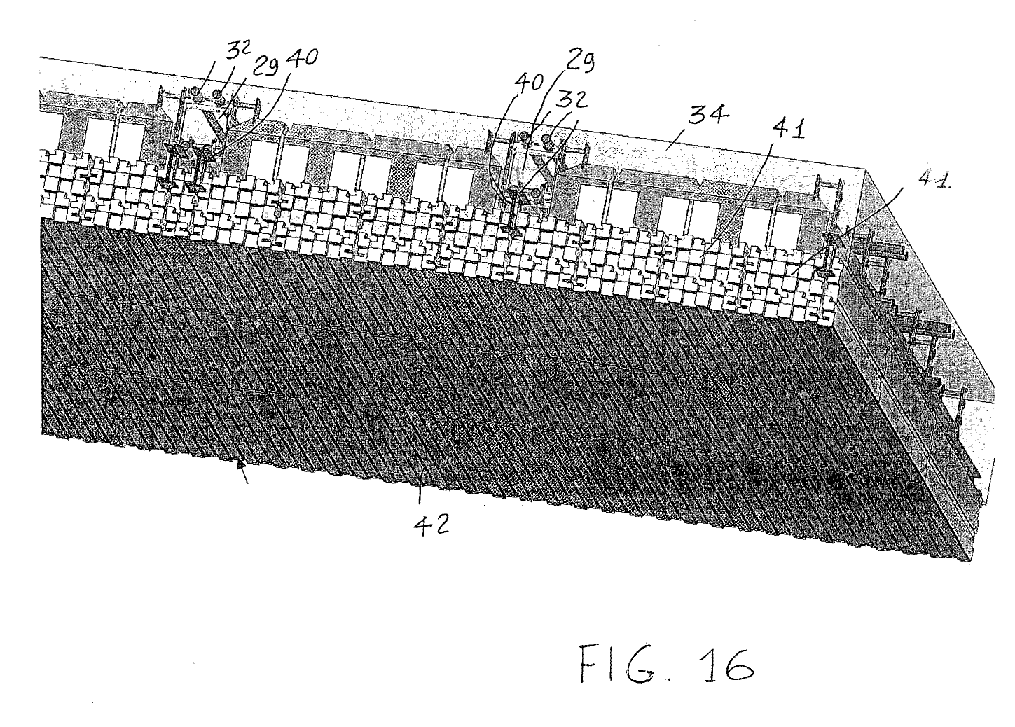

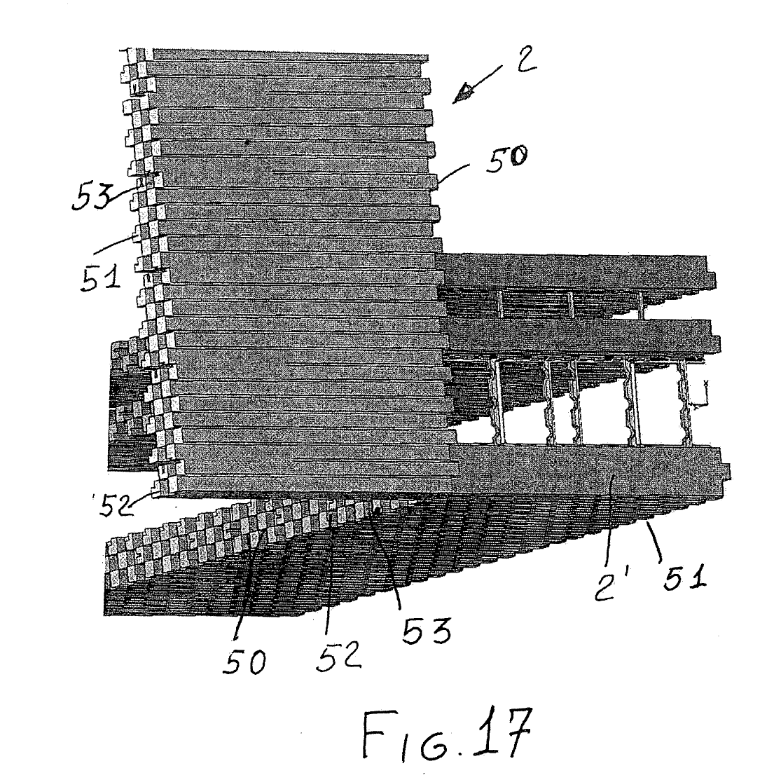

FIG. 16 shows a side cross-sectioned view of a wall or floor 2, including a plurality of beam elements 29 reinforced by metal rods 32.

In said beams 29 are partially embedded a plurality of connection “H” bars 40, supporting a wall 41 constituted by a thermally insulating panel.

This wall 41 comprises a plurality of dovetail cavities 42 for latching therein a further thermally insulating panel.

Moreover, to said wall 41 dovetail cavities it is possible to apply a coating plaster material, the attachment thereof is facilitated just owing to the provision of said dovetail cavities.

As shown in FIG. 17, the two panels 2 and 2′ comprise, at their side surfaces 50 and 51, a plurality of tooth elements 52 each of which is adapted to firmly engage in a cavity 53 formed at the side end portions of another panel.

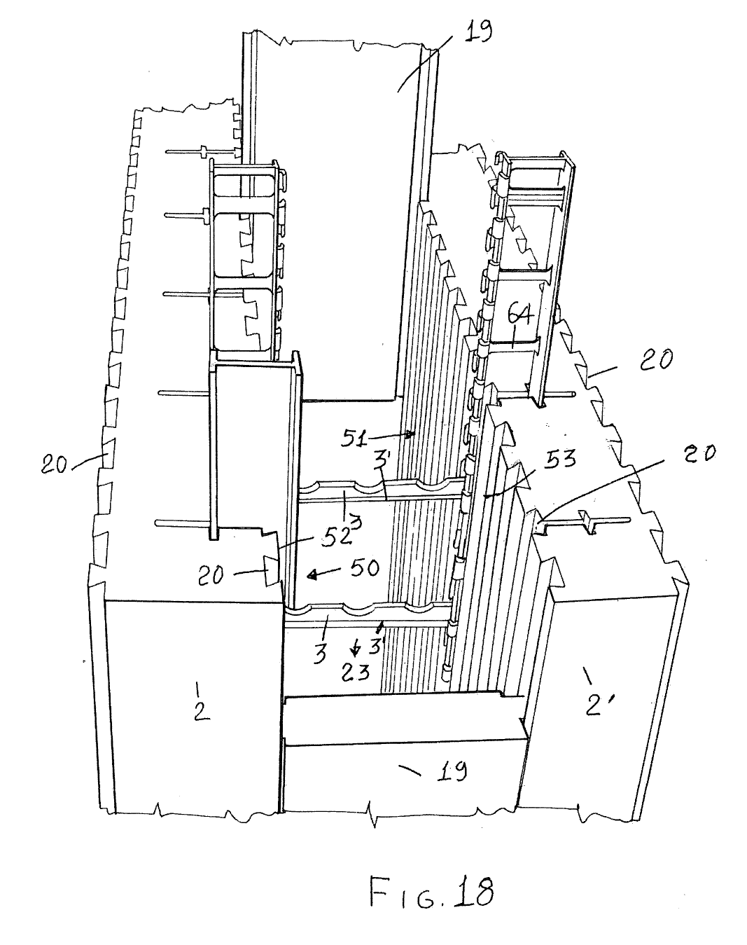

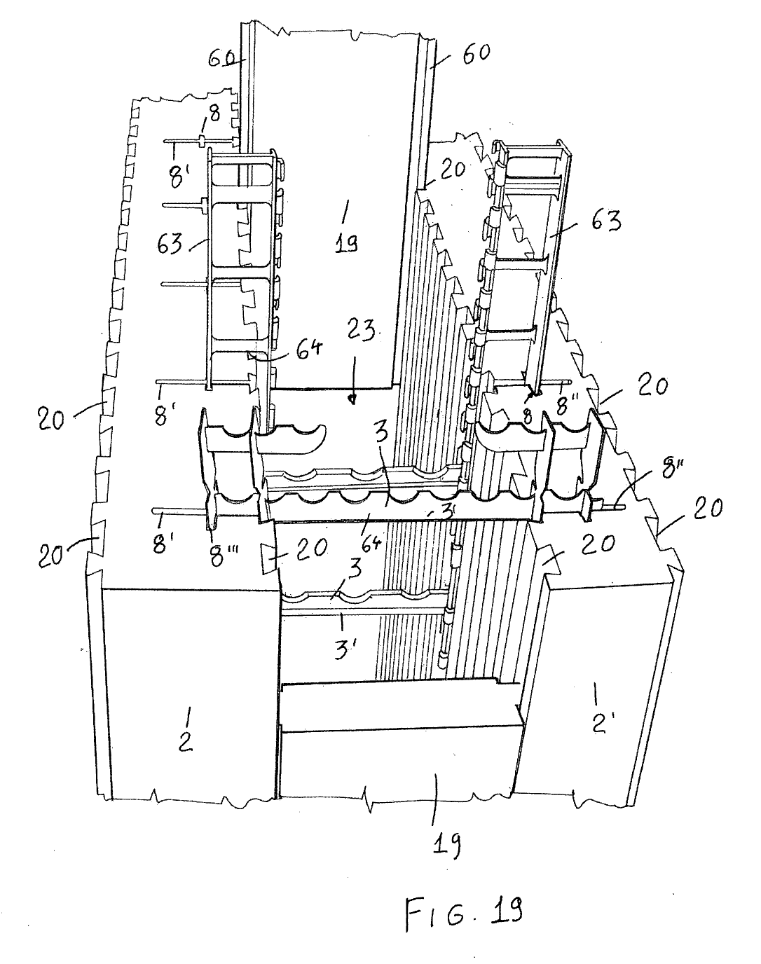

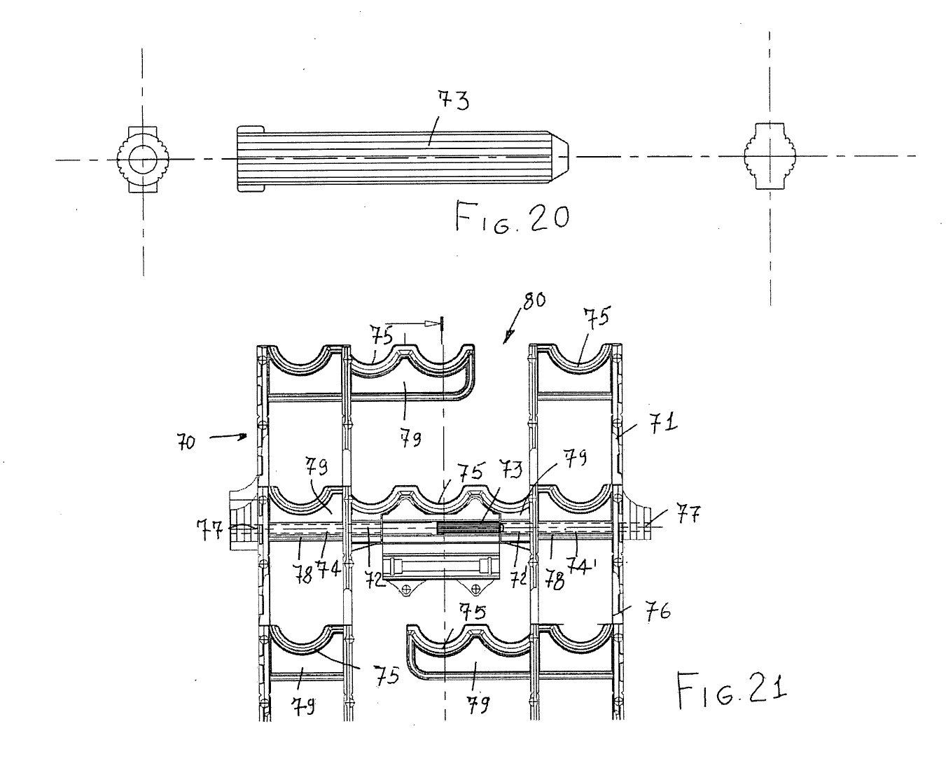

With reference to FIGS. 18 and 19, they show two formworks clearly illustrating the two panels 2 and 2′, including dovetail cavities and longitudinal projections, for housing both head and diaphragms and for splitting the jet 19.

Said diaphragms comprise dovetail end portions 60, for engaging in said dovetail cavities 20, formed in said two panels 2 and 2′.

FIGS. 18 and 19 shows moreover two upright elements 63 including upright arms 64 thereat are fitted spacer elements 3 including throughgoing perforated tubular elements 3′, in turn coupled two perforated tubular arms 64 thereby pneumatically communicating two panels 2 and 2′, while conveying air through the slots 8″ and 8′ ending near the side end portions of the panels 2 and 2′, thereby allowing the article of manufactures formed upon pouring cement or concrete to have transpirable characteristics.

It should be apparent that the spacer elements 3 engaging in slots 8′″ cross arranged of said slots 8′ and 8″ operate as spacer element anchoring members.

FIG. 21 shows a connector operating as spacer element and including two uprights 70 and 71 engaging in cross slots 8 formed in the panels 2 and 2′.

Said uprights 70 and 71 are rigidly coupled to a plurality of side arms having a plurality of housing seats 75 which may bear both pipes, reinforcement iron elements and electric conveying tubes.

The connector 80 shown in FIG. 21 comprises moreover tubular ducts 74 and 74′ which are telescopically engaged with one another and comprise a valve 73 allowing air to pass through the tubular ducts 74, 72, 72′ and 74′ to be conveyed through substantially the overall formwork thereby allowing the concrete wall or article of manufacture poured in operation between the spaced panels 2 and 2′ connected by the subject connector 80 to properly transpire.

For facilitating such a transpiring, the tubular ducts 74 and 74′, 72 and 72′ are suitably perforated.

It has been found that the invention fully achieves the intended aim and objects.

In fact, the invention has provided a building construction operating as an insulating formwork, allowing to make reinforced concrete transpirable walls and frames, owing to the provision of connecting elements having a tubular constructor and allowing air to pass through the wall, thereby communicating outer surfaces thereof.

In practicing the invention, the used materials, as well as the contingent size and shapes, can be any, depending on requirements.

1. A building construction for making transpirable walls and floors, comprising foamed transpirable panels in plastic material, between which perforated coupling elements are interposed, that operate as spacer elements adapted to join the panels to one another, while allowing air to pass therethrough, wherein the panels are equipped, next to one or more of their surfaces, with dovetail cavities, with which corresponding dovetail ridges are engaged, obtained on modular walls to be coupled with the above panels, the modular walls having a different thickness and being made by mutually coupling many individual panels.

2. The building construction of claim 1, wherein the panels are made of various transpiring materials, such as foamed-extruded polystyrene, plywood, cement-wood, perlite mixed with cement and/or adhesive materials, cellular cements, plasterboard, concrete, pumice or other insulating material.

3. The building construction of claim 1, wherein the perforated coupling elements have a contoured coupling element body including a plurality of seats for supporting horizontal reinforcement iron elements and a plurality of eyelets for engaging therein vertical reinforcement iron elements.

4. The building construction of claim 1, wherein a variable number of polystyrene elements are applied onto the polystyrene base, that forms the caisson block.

5. The building construction of claim 1, wherein the panels comprise a plurality of dovetail cavities and ridges, adapted to operate as latching elements for facilitating a latching of plaster materials thereon.

6. The building construction of claim 1, wherein the panels of the construction comprise a plurality of side dovetail cavities for engaging therein respective end portions of separating diaphragms adapted to operate as formworks for pouring therein pillars or ledges or lintels or door and window jambs.

7. The building construction of claim 1, wherein the building construction comprises a plurality of panels delimitating a space therein operating as formwork for arranging reinforcement iron elements therein, and for receiving a pouring concrete material, thereby providing support pillars.

8. The building construction of claim 1, wherein the polystyrene elements are overlapped onto one another, thereby forming ridge regions delimiting cavities therebetween for engaging therein reinforcement iron elements, of different types and shapes, the cavities being moreover provided for pouring cement thereinto, thereby forming beans delimited by the polystyrene elements, forming formwork elements, as a cement material is poured thereinto.

9. The building construction of claim 1, wherein the building construction comprises a floor or a wall comprising a base element made of polystyrene or of any of the other insulating materials, and a floor or intrados including corresponding dovetail ridges and cavities is connected thereto, through dovetail cavities.

10. The building construction of claim 1, wherein the building construction further comprises H-shaped connecting bars coupling the floor or intrados to beams made by pouring cement material into cavities formed between foamed or extruded polystyrene material.

11. The building construction of claim 1, wherein the building construction comprises a plurality of cup elements, made of a regenerated plastic material, wherein, above the cup elements, a concrete layer is poured.

12. The building construction of claim 1, wherein the floor comprises beam elements reinforced by metal rods, in the beams H-shaped connecting bars being partially embedded, the connecting bars supporting a wall constituted by a thermally insulating panel.

13. The building construction of claim 1, wherein the wall comprises a plurality of dovetail cavities, and a further thermally-insulating panel is latched thereto, the dovetail cavities being adapted to allow a plaster material to be affixed thereto.

14. The building construction of claim 1, wherein the building construction comprises a plurality of panels including, at side surfaces thereof, a multiple-tooth element arrangement allowing the panels to be orthogonally coupled at different positions and according to different cross sections, thereby allowing the panels to be reversed.

15. The building construction of claim 1, wherein the building construction comprises a connector operating as spacer element, the connector comprising two uprights engaging in the cross slots formed in the panels, the uprights being rigid with a plurality of side arms including respective housing seats or recesses for applying thereon pipes, reinforcement iron elements and electric cable containing tubes, the connector further comprising tubular ducts including a valve allowing air to pass through the tubular ducts while substantially passing through all the formwork and allowing a concrete wall to transpire, the concrete wall being poured between the panels coupled to the connector, the tubular ducts being so perforated as to allow a building article to transpire upon pouring it.

16. (canceled)

17. (canceled)

18. (canceled)

19. (canceled)

20. (canceled)
